(19) United States
(12) Patent Application Publication
(10) Pub. No.: US 2008/0124468 A1
(43) Pub. Date: May 29, 2008

(54) PLATING METHOD

(75) Inventors: Il-Jin Kim, Suwon-si (KR); Yoon-Hee Lee, Seo-gu (KR); Shin-Chul Kang, Seoul (KR); Hoon-Soo Park, Gwangmyeong-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/873,932

(22) Filed: Oct. 17, 2007

(30) Foreign Application Priority Data
Nov. 23, 2006 (KR) 116470/2006

(51) Int. Cl. B05D 3/06

(52) U.S. Cl. 427/337; 204/157.15

(57) ABSTRACT

Disclosed is a plating method which, includes preparing a plating base; printing a plating pattern on a plating surface of the plating base; and plating the plating surface of the plating base. During plating, a plating layer is formed on a portion where the plating pattern is not printed. The method is provided for contributing to diversification of the external appearance of a compact type device such as portable terminals, is capable of printing three-dimensional patterns as well as a trademark and a logo, and is capable of highlighting the metallic texture together with three dimensional solid patterns.

### PRIORITY

This application claims priority under 35 U.S.C. §119(a) to an application entitled “Plating Method” filed in the Korean Industrial Property Office on Nov. 23, 2006 and assigned Serial No. 2006-0116470, the contents of which are hereby incorporated by reference.

### BACKGROUND OF THE INVENTION

1. Field of the Invention

The present invention relates to cladding of electronic appliances such as a portable mobile communication terminal, and more particularly to a plating method of a case of a compact type electronic appliance.

2. Description of the Related Art

Generally, when selecting domestic appliances, a user takes functionality, performance, durability, and other criteria into consideration. However, since some appliances such as a refrigerator, an air conditioner, and other similar appliances occupy large space and have simple appearances, it has been recently attempted to makes the external appearance thereof aesthetically pleasing. The domestic appliances belong among interior decorations, so that such efforts to improve the external appearance thereof is not only for simple consideration of splendor, but also for giving prominence to products made by a manufacturer.

Meanwhile, portable terminals, such as cellular phones, PDAs, and the like have been developed to have a compact size in consideration of portability thereof, and are typically made of synthetic resinous material to have a light weight. Since these compact devices typically made of synthetic resin are relatively easy in diversifying colors, or printing logo thereon, it has been attempted to improve their design, rather than making the external appearance thereof aesthetically pleasing.

As portable terminals, such as cellular phones, have recently been provided with a multimedia function efforts for miniaturization are concentrated on slimming as well as on securing a size of a display. In the tendency of slimming, in order to secure the structural stability of a terminal, the terminal has recently been made of metallic material.

However, a metallic case of the terminal has a great difficulty in having diversified colors, or emblazoning thereon a trademark, logo, or the like. That is, where the metallic case is printed with general paint and the like, paint is likely to be damaged by scratching, etc. In addition, conventional simple printing technology merely embodies a two-dimensional pattern, so that it is limited in diversifying the external appearance of the terminal.

### SUMMARY OF THE INVENTION

Accordingly, the present invention has been made to solve the above-mentioned problems occurring in the prior art, and an object of the present invention is to provide a plating method for contributing to diversification of the external appearance of compact type devices such as portable terminals.

Another object of the present invention is to provide a plating method capable of printing three-dimensional patterns as well as a trademark and logo on a case of a portable terminal or the like.

Still another object of the present invention is to provide a plating method capable of highlighting the metallic texture of a portable terminal or the like to thereby improve its design.

In order to accomplish these objects, there is provided a plating method including preparing a plating base; printing a plating pattern on a plating surface of the plating base; and plating the plating surface of the plating base, wherein in the plating step, a plating layer is formed on a portion where the plating pattern is not printed.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view illustrating the state where a plating pattern is printed on a plating base in the course of a plating method according to a preferred embodiment of the invention;

FIG. 2 is a sectional view illustrating the state where a plating layer is formed on the plating base illustrated in FIG. 1;

FIG. 3 is a sectional view illustrating the state where the plating pattern is removed from the plating base illustrated in FIG. 2;

FIG. 4 is a sectional view illustrating the state where a protective layer is formed on a plating surface of the plating base illustrated in FIG. 3; and

FIGS. 5 A-C illustrate portable terminals decorated by the plating method according to preferred embodiment of the invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

In a plating method of the invention, a plating pattern is printed on one surface of a plating base, and a plating layer is formed on the remainder of the plating pattern 13 to thereby form a trademark, logo, a three-dimensional pattern, or the like on the plating surface.

The plating method includes preparing the plating base, printing the plating pattern on a plating surface of the plating base, and plating the plating surface of the plating base, wherein in the plating step, the plating layer is formed on a portion where the plating pattern is not printed.

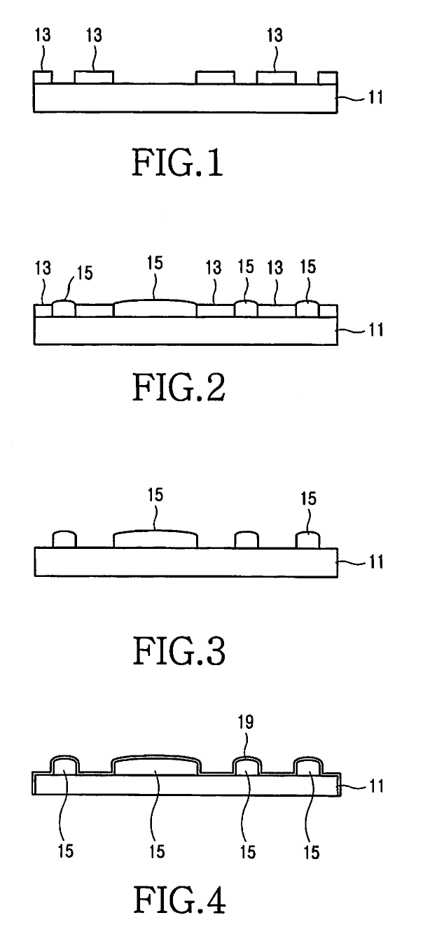

Description will now be made to the plating method according to the preferred embodiment of the present invention with reference to FIGS. 1 to 5.

In FIG. 1, the plating base 11 is formed to have a seed layer (not shown) so as to enable plating on the outer surface of a case of a portable terminal or the like made of metallic material or synthetic resin. The preparation step corresponds to a step in which a plating object is fabricated using such a material able to be plated.

In addition, in the printing step, as illustrated in FIG. 1, the plating pattern 13 is printed on the outer surface of the plating base 11, i.e., the plating surface. Herein, the plating pattern 13 is formed on the remainder of a pattern intended to be formed on the plating surface. That is, the plating pattern 13 is formed on a portion other than a portion intended to form the plating layer 15. Here, the material used for forming the plating pattern 13 is preferably a bi-liquid type paint including an applying agent and a hardener, which are applied to and cured on the plating surface of the plating base 11.

FIG. 2 illustrates the state where the plating layer 15 is formed on the plating surface through the plating step. Here, it can be seen that the plating layer 15 is formed only on the remainder of the plating pattern 13, i.e., a portion intended to practically form a pattern.

FIG. 3 illustrates the state where the plating pattern 13 printed on the plating surface is removed. Since the plating pattern 13 is not for practically printing on the external case of a terminal or the like, it is removed after the plating layer 15 is formed. In the meantime, when it is intended to form the plating layer 15 in a different color, the plating layer 15 can be diversified in color through a coloring step. In the coloring step, the surface of the plating layer 15 can be colored by applying it with a general paint, but such a simple application of the paint to the metallic plating layer 15 may cause a problem of discoloration or decolorization. Thus, in the coloring step, it is preferable that the plating layer 15 itself be colored to have a designed color through an evaporation process and an electrodeposition process.

Only by removing the plating pattern 13, the plating of the case of the portable terminal, i.e., the plating base 11, is completed, but it may be further performed with a coating process through a formation step of a protective layer 19 to protect the plating layer 15 formed on the plating surface of the plating base 11 and the outer surface of the plating base 11, as illustrated in FIG. 4.

By coating the plating surface, on which the plating layer 15 is formed, with the protective layer, a gloss is formed on a product, such as a terminal, in conformity with the appearance of the product, which can exhibit a metallic texture, or otherwise a pastel texture can be realized through a flat coating.

While the plating layer 15 has been illustrated in the drawings to protrude from the plating surface, this is for simplification of description. In practically fabricating a product, it is preferable that a thickness, a shape, and the like of the plating layer 15 be formed such that they are viewed in three dimensions. The thickness and the shape of the plating layer may be diversely preset to adapt them to a practical product by persons skilled in the art. While the thickness of the plating layer 15 is nevertheless thin, a feeling of solidity can be realized in three dimensions because an angle and an amount of reflecting visible rays can be different due to a difference in the plating thickness.

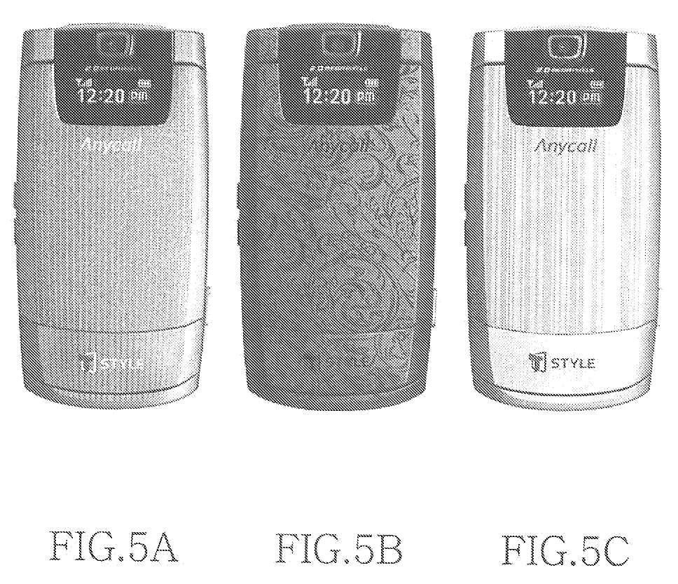

FIG. 5 illustrates examples where a trademark, logo, and a pattern are respectively formed on the cases of portable terminals through the plating method as such. FIG. 5A shows an appearance in which irregular stripe patterns are formed in blue-based ground color, and the maker's brand name and service brand logo of the radio communication carrier are respectively formed. FIG. 5B shows an appearance in which diverse curved patterns are formed in red-based ground color all around the terminal, and similar to FIG. 5A, the maker's brand name and service brand logo of the radio communication carrier are respectively formed. FIG. 5C shows an appearance in which stripe patterns, irregular in their width and interval, are formed in silver-based ground color, and a logo such as maker's brand is formed on the outer case.

Such apparent patterns of the case of the portable terminal may be diversely formed like a pattern repeating a regular damascene shape, a pattern in which grooves and protrusions are alternatively repeated according to a certain design, or the like. In such patterns, a feeling of solidity is realized due to a difference between the plating layer and the non-plated surface.

In the case of a portable terminal that is fabricated with a conventional metallic case, it has a single colored appearance color and a logo that is formed through a general printing or imprinting. However, by using the plating method of the invention, it is easy to form a logo and the like, and it is possible to form diverse solid patterns all over the terminal.

As set forth before, according to the plating method of the invention, the plating layers with diverse patterns are formed on the exterior of a compact type device such as a portable terminal and the like, so that it is possible to contribute to diversification of the external appearance of a compact type device. Further, through the plating method of the present invention, it is possible to print three-dimension patterns, together with a trademark and logo, on the outer surface of a portable terminal. Moreover, by coloring the plating layer through an evaporation process and an electrodeposition process before removing the plating patterns printed on the plating surface, it is possible to raise diverse colors. Furthermore, since it is possible to design a damascene pattern and a pattern in which grooves and the protrusions are alternatively repeated, the invention has an advantage to give prominence to the metallic texture as well as a feeling of solidity in three dimensions.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A plating method comprising the steps of:
preparing a plating base;
printing a plating pattern on a plating surface of the plating base; and
plating the plating surface of the plating base,
wherein in the plating step, a plating layer is formed on a portion where the plating pattern is not printed.

2. The method as claimed in claim 1, wherein in the printing step, the plating pattern is printed with a bi-liquid type paint on the portion of the plating surface other than a portion intended to form the plating layer.

3. The method as claimed in claim 1, further comprising coloring the plating layer by performing an evaporation process and an electrodeposition process after the plating layer is formed.

4. The method as claimed in claim 1, further comprising removing the plating pattern printed on the plating surface after the plating layer is formed.

5. The method as claimed in claim 4, further comprising coating a protective layer onto the plating surface including the plating layer after the plating pattern is removed.

6. The method as claimed in claim 1, wherein the plating base is a case of a portable terminal, and the plating surface is an outer surface of the case.
